(19) United States
(12) Patent Application Publication
(10) Pub. No.: US 2023/0283970 A1
(43) Pub. Date: Sep. 7, 2023

(54) METHOD FOR OPERATING A HEARING DEVICE

(71) Applicant: Sivantos Pte. Ltd., Singapore (SG)

(72) Inventors: Gabriel GOMEZ, Erlangen (DE); Cecil WILSON, Erlangen (DE); Tobias Daniel ROSENKRANZ, Erlangen (DE)

(73) Assignee: Sivantos Pte. Ltd., Singapore (SG)

(21) Appl. No.: 18/117,809

(22) Filed: Mar. 6, 2023

(30) Foreign Application Priority Data
Mar. 7, 2022 (DE) 10 2022 202 266.1

(51) Int. Cl. H04R 25/00; G10K 15/08; G10L 21/028

(52) U.S. Cl. CPC H04R 25/505; G10K 15/08; G10L 21/028; H04R 25/40; H04R 2225/43

(57) ABSTRACT

A method for operating a hearing device. In this method, an entire audio signal is detected by means of a microphone. The entire audio signal is divided into a first audio signal and a second audio signal. A speech intelligibility of the second audio signal is reduced. The first audio signal and the second audio signal are combined to form an output signal, and the output signal is output by means of an output device. Further, a hearing device is provided.

This nonprovisional application claims priority under 35 U.S.C. § 119(a) to German Patent Application No. 10 2022 202 266.1, which was filed in Germany on Mar. 7, 2022, and which is herein incorporated by reference.

### BACKGROUND OF THE INVENTION

### Field of the Invention

The invention relates to a method for operating a hearing device and to a hearing device. The hearing device is preferably a hearing aid.

### Description of the Background Art

Persons who suffer from a reduction in hearing ability usually use a hearing aid. In this case, an ambient sound is converted into an electrical (audio/sound) signal generally by means of a microphone, therefore, an electromechanical acoustic transducer, so that the electrical signal is detected. The detected electrical signals are processed by an amplifier circuit and introduced into the ear canal of the person by a further electromechanical transducer in the form of a receiver. In most cases, processing of the detected sound signals also takes place, for which a signal processor of the amplifier circuit is usually used. Here the amplification is adjusted to a possible hearing loss of the hearing device wearer.

If the ambient sound also contains sound from an interference source, therefore, an unwanted source, this is also detected and, due to the amplification, introduced amplified into the person’s ear canal. Thus, identification of the desired components in the sound emitted into the ear canal is made more difficult for the person. A directional microphone is usually used to avoid this. This is set to a desired sound source, so that mainly the sound emitted by it is detected or at least further processed by means of the electromechanical acoustic transducer. This part of the ambient sound is emitted amplified into the ear canal by the amplifier circuit. However, it still contains part of the sound emitted by the interference source, so that this is perceived by the person, even if it is not amplified, for example.

In this case, it is possible that the source of interference emits information intelligible to humans. In this case, the source of interference is, for example, a multimedia device, such as a television or radio, or speaking, uninvolved persons. Now, when the person wearing the hearing aid has a conversation with a counterpart, words from the interfering sources also enter the ear canal, which makes it more difficult for the wearer of the hearing aid to follow the conversation with the counterpart.

### SUMMARY OF THE INVENTION

It is therefore an object of the present invention to provide an especially suitable method for operating a hearing device as well as an especially suitable hearing device, whereby in particular comfort is increased and/or the following of a conversation is facilitated.

The method is used, for example, to operate a hearing device. For example, the hearing device is an earphone or comprises an earphone. However, the hearing device is particularly preferably a hearing aid. The hearing aid is used to assist a person suffering from a reduction in hearing ability. In other words, the hearing aid is a medical device by means of which, for example, partial hearing loss is compensated. The hearing aid is, for example, a “receiver-in-the-canal” hearing aid (RIC), an in-the-ear hearing aid, such as an “in-the-ear” hearing aid, an “in-the-canal” hearing aid (ITC), or a “completely-in-canal” hearing aid (CIC), hearing aid glasses, a pocket hearing aid, a bone conduction hearing aid, or an implant. The hearing aid is particularly preferably a behind-the-ear hearing aid, which is worn behind an auricle.

The hearing device is provided and set up to be worn on the human body. In other words, the hearing device preferably comprises a holding device, by means of which attachment to the human body is possible. Provided the hearing device is a hearing aid, the hearing device is provided and set up to be placed, for example, behind the ear or within an ear canal. In particular, the hearing device is cordless and intended and set up to be inserted at least partially into an ear canal. Particularly preferably, the hearing device comprises an energy storage, by means of which a power supply is provided.

The hearing device further comprises a microphone that is used to detect sound. In particular, during operation an ambient sound or at least a part thereof is detected by means of the microphone. The microphone is in particular an electromechanical acoustic transducer. For example, the microphone has only a single microphone unit or multiple microphone units that interact with one another. Each of the microphone units expediently has a membrane that is made to vibrate by means of sound waves, wherein the vibrations are converted into an electrical signal by means of a corresponding pickup device, such as a magnet moved in a coil. Thus, by means of the particular microphone unit, it is possible to detect an audio signal based on the sound impinging on the microphone unit. The microphone units are designed unidirectional in particular. The microphone is expediently arranged at least partially within a housing of the hearing device and is thus at least partially protected.

Further, the hearing device has an output device for outputting an output signal. The output signal here is in particular an electrical signal. The output device is, for example, an implant or, particularly preferably, also an electromechanical acoustic transducer, preferably a loudspeaker, also referred to as a receiver. Depending on the embodiment of the hearing device, in the intended state the output device is arranged at least partially within an ear canal of a wearer of the hearing device, therefore, a person, or at least acoustically connected thereto.

According to an examplary method, an entire audio signal is detected by means of the microphone. For example, the entire audio signal corresponds to the full ambient sound around the hearing device and has, in particular, different components. Subsequently, the entire audio signal is divided into a first audio signal and a second audio signal. In this case, for example, the individual components of the entire audio signal are divided either into the first audio signal or the second audio signal, or preferably individual components of the entire audio signal are assigned to both the first and second audio signal. At least there are the two audio signals after the dividing is complete, wherein the first audio signal preferably comprises components not included in the second audio signal and vice versa. In particular, the first audio signal contains components of the entire audio signal, therefore, also of the ambient sound, that are important to the wearer of the hearing device, therefore, that the wearer of the hearing device wants to hear. In particular, the dividing of the entire audio signal into the two audio signals is done in such a way that the first audio signal contains the components or parts of the entire audio signal that the wearer of the hearing device wants to hear, whereas the second audio signal contains the components or parts of the entire audio signal that the wearer of the hearing device does not want to hear.

In a subsequent work step, the speech intelligibility of the second audio signal is reduced. In other words, the second audio signal is processed in such a way that subsequently speech intelligibility is reduced. Consequently, if the second audio signal were subsequently output by means of the output device, any speech contained therein would be unintelligible or only difficult to understand for the wearer of the hearing device. At least, however, the intelligibility is reduced compared to the case if the reduction had not taken place.

In particular, signal processing is carried out to reduce speech intelligibility. For example, in addition a sound pressure or volume of the second audio signal is reduced, wherein this reduction is not understood to mean in particular a reduction in speech intelligibility. Also, no removal of the second audio signal occurs during the reduction, so that acoustic components continue to be present in the second audio signal after the reduction. In a further alternative, noise suppression or reduction is also performed.

In a subsequent work step, the first and second audio signals are combined to form an output signal. In other words, the modified, therefore processed, second audio signal and the first audio signal are combined to form the output signal, for which purpose they are in particular added. Alternatively, a frequency-dependent combining is performed, for example, wherein certain frequencies are used only by the first audio signal and other frequencies are used only by the second audio signal, so that the output signal is created.

Subsequently, the output signal is output by means of the output device. Consequently, the output signal is converted into sound or is at least perceptible to a person wearing the hearing device, therefore, the wearer of the hearing device. In this case, the speech intelligibility of the components of the entire audio signal, those associated with the second audio signal, is reduced. Consequently, it is simplified for the wearer of the hearing device to hear the components of the entire audio signal associated with the first audio signal than if the unprocessed entire audio signal were output.

Thus, if the wearer of the hearing device wishes to follow a conversation with a particular person, the components of the sound/entire audio signal associated in this conversation will be associated with the first audio signal in particular. The remaining components of the entire audio signal are associated with the second audio signal in particular and consequently their speech intelligibility is reduced. Thus, a contrast of speech intelligibility between the individual components is increased. Therefore, the components contained in the second audio signal are not mistaken by the wearer of the hearing device for parts of the conversation, so that it easier for the wearer to follow the conversation. In summary, there is no interference for the wearer by fragments of conversation or the like, which are part of the second audio signal, when following the conversation. This increases the comfort for the hearing device wearer and makes it easier to follow a conversation.

Particularly preferably, the hearing device has a directional microphone. Detecting sound from a preferred direction is possible hereby by means of the directional microphone. In particular, the correct directional microphone has two or more of the possible microphone units, which are suitably designed to be unidirectional. Here, a sound signal is detected by means of each of the microphone units, wherein the two sound signals in particular form the entire audio signal. A preferred direction is defined by means of a certain combination of the two sound signals, wherein in particular a temporal offset, by means of which the two sound signals are combined, is selected depending on an arrangement of the microphone units relative to one another and to the preferred direction. In particular, the signal created in this way represents the first audio signal. The second audio signal corresponds in particular to the complement thereof. In particular, the first audio signal corresponds to a cardioid, and the second audio signal corresponds to the corresponding anti-cardioid. Thus, the first audio signal is mainly associated with a different spatial area than the second audio signal, and the two audio signals thus have different preferred pickup directions.

For example, the microphone is formed by means of the directional microphone. In an alternative, the hearing device comprises, in addition to the directional microphone, a further microphone or a separate microphone unit by means of which, for example, the second audio signal is generated, so that the first and second audio signals are already divided when the sound is detected.

In a refinement, additional information, which is provided by a further hearing device, for example, is used to divide the two audio signals, so that the hearing device and the further hearing device are each a component of a hearing device system, which is thus designed to be binaural. The additional information here concerns the dividing of the entire audio signal into the two audio signals. The invention also relates to a hearing device system having two such hearing devices, wherein by means of one of the hearing devices the additional information is provided which is taken into account in the other hearing device for dividing the entire audio signal into the two audio signals. In a further alternative, for example, the first audio signal is provided by means of one of the hearing devices and the second audio signal is provided by means of the other. For example, the two hearing devices of the hearing device system are designed similar to one another, or only one of them is operated according to the method.

To reduce speech intelligibility, for example, the second audio signal is filtered using a low-pass filter. In other words, frequencies greater than a cutoff frequency are removed from the second audio signal, or at least attenuated relatively greatly. The cutoff frequency is, for example, between 100 Hz and 1 kHz and preferably between 200 Hz and 500 Hz. Due to the reduction of high frequencies, the components required for speech intelligibility are reduced relatively greatly, whereby individual components of the second audio signal are nevertheless retained, by means of which, for example, still present intelligible components in the second audio signal are masked, so that the speech intelligibility is reduced in comparison to, for example, complete removal. Also, the second audio signal processed in this way is used to mask interfering sounds contained in the first audio signal after their combining, which would not occur, for example, if the second audio signal were completely removed.

Alternatively or in combination, for reduction, the second audio signal may be smoothed in the spectrum temporal domain or at least a part of the spectrum of the second audio signal. For this purpose, a Fourier transform, in particular an FFT, is first carried out and the individual amplitudes for the individual frequencies are determined. This spectrum is smoothed, for example, in particular completely or at least a part thereof. In this way, the individual components of the second audio signal are washed out and the intelligibility of speech is thus reduced.

As an alternative to this, a spectral resolution may be reduced in order to reduce speech intelligibility. In particular, a Fourier transform is also performed for this purpose. The amplitudes of a number of frequencies of the second audio signal are combined to form a common amplitude, which is assigned to only one frequency, for which, for example, an averaging is performed. As an alternative to this, for example, the second audio signal is filtered with a further filter to reduce the spectral resolution.

In a further alternative, a dynamic range of the second audio signal may be reduced in order to reduce speech intelligibility. In particular, appropriate filters, such as an IIR or an FIR filter, are used for this purpose. When the dynamic range is reduced, the maxima and minima in particular are adjusted, wherein this is done, for example, for the amplitudes of the individual frequencies in the frequency domain of the second audio signal. In a further alternative, a frequency-selective amplification of the second audio signal takes place to reduce speech intelligibility. In other words, certain frequencies are amplified and/or others are reduced, for example. For example, the same frequencies are always amplified/reduced, or this is done in particular in a pattern or randomly. This also reduces speech intelligibility. In a further alternative, the second audio signal is compressed so that in particular a shift in frequencies occurs. In a further alternative, for example, amplitudes assigned to different frequencies are interchanged.

In a further alternative to reduce speech intelligibility, a reverberation can be added, which in particular is created artificially. In other words, the second audio signal is again mapped onto itself after a certain period of time, namely, the reverberation time. For example, the second audio signal is mapped unchanged onto itself as reverberation or is preferably processed. For this purpose, it is attenuated or a frequency response is changed, for example. Particularly preferably, the reverberation is created based on the already modified second audio signal. In other words, to create the reverberation, the second audio signal is used in which speech intelligibility is reduced, therefore, for example, which is already filtered, or whose dynamic range is reduced. Preferably, a convolution is performed to create the reverberation or, for example, an IIR feedback signal is used.

For example, the reverberation or the way the reverberation is created is constant or adapted to the current listening situation, for example. Alternatively, the frequency response and/or reverberation time of the reverberation are changed. This is done, for example, according to a predefined pattern or preferably randomly. In this way, becoming accustomed to a certain reverberation is ruled out for the wearer of the hearing device, so that the speech intelligibility of the second audio signal is reduced even for a relatively long period of time. To change the frequency response, the room impulse response in particular, which is used in the potential convolution, is changed.

In summary, to reduce the speech intelligibility of the second audio signal, it is processed in terms of signals, so that subsequently the reverberation time, which is a criterion for evaluating speech intelligibility, is changed. Alternatively or in combination, after the speech intelligibility has been reduced, a degree of definition, a clarity index, or a center time of the second audio signal is changed. Alternatively, at least the speech transmission index (STI or RASTI) describing a modulation transmission index is changed.

For example, the manner of reducing speech intelligibility is effected by a user, therefore, in particular the wearer of the hearing device. In other words, the user specifies which method is to be used to reduce speech intelligibility. Alternatively or in combination therewith, the extent by which speech intelligibility is reduced is determined by a user, for example. Alternatively, this is specified by the hearing device manufacturer or by an audiologist.

Particularly preferably, however, the method of reducing speech intelligibility is carried out depending on an actual listening situation. Alternatively or particularly preferably in combination with this, the extent to which speech intelligibility is reduced also occurs depending on the current listening situation. For this purpose, in particular according to the method, the current listening situation is first determined for which a corresponding classification is preferably used. Thus, the speech intelligibility is changed differently in different listening situations. For example, in a conversational situation in a crowded room, the speech intelligibility of the second audio signal is changed in a different way compared to, for example, a listening situation in which the wearer of the hearing device moves about in the open air. Thus, on the one hand, it is always made possible for the wearer of the hearing device to follow a conversation, wherein nevertheless excessive information is not lost due to the method that is important to the hearing device wearer due to the reduction in speech intelligibility.

For example, the first audio signal is not processed or it is adjusted, for example, depending on a hearing loss of the wearer of the hearing device. Particularly preferably, the speech intelligibility of the first audio signal is increased. For example, filtering of the first audio signal is performed for this purpose, preferably by means of a high-pass filter or a band-pass filter. Alternatively or in combination therewith, a reverberation of the first audio signal is removed or at least reduced. For example, to increase speech intelligibility, relatively high frequencies are boosted and thus reproduced amplified, whereas low frequencies are reduced. Thus, following the conversation is further simplified for the wearer.

The hearing device has a microphone, an output device, and a signal processing unit. In particular, a signal path is formed by means of these, and the microphone is preferably used to detect sound and the output device is suitably used to output sound. For example, the hearing device is an earphone or comprises an earphone. In this case, the hearing device is designed as a so-called headset, for example. However, the hearing device is particularly preferably a hearing aid. The hearing aid device is used to assist a person suffering from a reduction in hearing ability. In other words, the hearing aid is a medical device by means of which, for example, partial hearing loss is compensated. The hearing aid is, for example, a “receiver-in-the-canal” hearing aid (RIC), an in-the-ear hearing aid, such as an “in-the-ear” hearing aid, an “in-the-canal” hearing aid (ITC), or a “completely-in-canal” hearing aid (CIC), hearing aid glasses, a pocket hearing aid, a bone conduction hearing aid, or an implant. The hearing aid is particularly preferably a behind-the-ear hearing aid, which is worn behind an auricle.

The hearing device is operated according to a method in which an entire audio signal is detected by means of the microphone. The entire audio signal is divided into a first audio signal and a second audio signal. The speech intelligibility of the second audio signal is reduced, and the first audio signal and the second audio signal are combined to form one output signal. The output signal is output by means of the output device. For example, the dividing, reducing, and/or combining take place by means of the signal processing unit. In other words, the signal processing unit is suitable, in particular provided and set up, to perform the method at least partially or completely.

The hearing device expediently comprises a signal processor, which suitably forms the signal processing unit or is at least a component thereof. The signal processor is, for example, a digital signal processor (DSP) or is realized by means of analog components. By means of the signal processor, in particular, the first audio signal is also adjusted, preferably depending on a possible hearing loss of a hearing device wearer. An A/D converter is expediently arranged between the microphone and the signal processing unit, for example, the signal processor, provided that the signal processor is designed as a digital signal processor. In particular, the signal processor is set depending on a set of parameters. An amplification in different frequency ranges is specified by means of the parameter set, so that the first audio signal is processed according to certain specifications, in particular depending on a hearing loss of the hearing device wearer. Particularly preferably, the hearing device additionally comprises an amplifier, or the amplifier is formed at least partially by means of the signal processor. For example, the amplifier is connected upstream or downstream of the signal processor in terms of signal technology.

The refinements and advantages described in connection with the method are to be applied analogously to the hearing device and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a hearing device;

FIG. 2 shows a method for operating the hearing device;

FIG. 3 shows in simplified form a frequency spectrum of a second audio signal; and

FIG. 4 shows in simplified form a time profile of a portion of the second audio signal.

### DETAILED DESCRIPTION

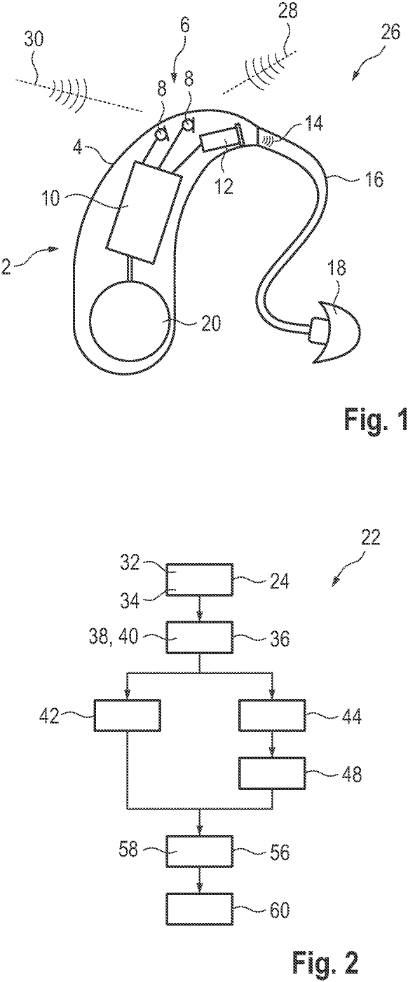

In FIG. 1, a hearing device 2 is shown in the form of a hearing aid, which is provided and designed to be worn behind an ear of a user (hearing device wearer, wearer). In other words, this is a behind-the-ear hearing aid. Hearing device 2 comprises a housing 4, which is made of a plastic. A microphone 6 with two microphone units 8, each in the form of an electromechanical transducer, is arranged within housing 4 and is designed to be omnidirectional. By changing a time offset between the acoustic signals detected by means of the omnidirectional microphone units 8, it is possible to change a directional characteristic of microphone 6 so that a directional microphone is realized. The two microphone units 8 are signal-coupled to a signal processing unit 10 which comprises an amplifier circuit and a signal processor. Signal processing unit 10 is further formed by circuit elements, such as, for example, electrical and/or electronic components. The signal processor is a digital signal processor (DSP) and is signal-connected to microphone units 8 via an A/D converter.

An output device 12 in the form of a receiver is signal-coupled to signal processing unit 10. During operation, an (electrical) signal provided by signal processing unit 10 is converted into an output sound 14, therefore, into sound waves, by means of output device 12, which is thus an electromechanical acoustic transducer. These are fed into a sound tube 16 one end of which is attached to housing 4. The other end of sound tube 16 is enclosed by a dome 18 which, in the intended state, is placed in an ear canal of the user, therefore, the wearer of hearing device 2. Here, dome 18 has multiple openings so that wearing comfort is increased. Power is supplied to signal processing unit 10, microphone 6, and output device 12 by means of a battery 20 located in housing 4.

FIG. 2 shows a method 22 for operating hearing device 2, which is carried out in part by signal processing unit 10. Thus, hearing device 2 is operated in accordance with method 22. In a first work step 24, an ambient sound 26 is detected by microphone 6, therefore, by each of microphone units 8. Ambient sound 26 has a first sound 28 (sound component) that originates from a sound source located in front of the wearer of hearing device 2. In the example shown, first sound 28 is emitted by a conversation partner of the wearer of hearing device 2 and comprises human speech. Further, ambient sound 26 comprises a second sound 30 emitted from an interference source in the opinion of the wearer of hearing device 2. In the example, these are conversations of other people whom the wearer of hearing device 2 does not want to follow, however.

By means of each of the microphone units 8, an electrical signal is created based on the ambient sound 26 detected in each case, each of which comprises components corresponding to the first and second sounds 28, 30, and which together represent an entire audio signal 32. In other words, the entire audio signal 32 corresponding to ambient sound 26 is detected by microphone 6. The entire audio signal 32 is subsequently routed to signal processing unit 10. The entire audio signal 32 is analyzed by signal processing unit 10 and an actual listening situation 34 is derived therefrom. Because there are multiple components that correspond to conversations of people in the entire audio signal 32, the current listening situation 34 in this example is assumed to be in a room with multiple people speaking.

In a subsequent second work step 36, the entire audio signal 32 is divided into a first audio signal 38 and a second audio signal 40. For this purpose, the two electrical signals created by microphone units 8 are added to one another with a certain time offset, so that a directional microphone is realized by means of microphone 6. Here, first audio signal 38 corresponds to an area which is located in front of hearing device 2 and is in particular a cardioid. Thus, first audio signal 38 substantially corresponds to first sound 28. For this purpose, the time offset is selected accordingly.

Second audio signal 40 corresponds to the opposite, and the combining of the electrical signals produced by the two microphone units 8 is carried out in the opposite manner, so that second audio signal 40 essentially contains second sound 30. Consequently, second audio signal 40 includes all sound sources located in an anti-cardioid behind hearing device 2 if the wearer of hearing device 2 is looking straight ahead. In summary, the dividing of the entire audio signal 32 into the two audio signals 38, 40 is carried out by means of the corresponding combining of the electrical signals detected by the two microphone units 8, so that a directional microphone is realized by means of microphone 6. In other words, the entire audio signal 32 is divided into the two audio signals 38, 40 by means of the directional microphone.

In a subsequent third work step 42, a speech intelligibility of first audio signal 38 is increased. For this purpose, a reverberation of first audio signal 38 is reduced and high frequencies are boosted and thus amplified. In particular, frequencies above a frequency of 100 Hz are amplified hereby, whereas lower frequencies are attenuated. Also, first audio signal 38 is adjusted according to a set of parameters stored in signal processing unit 10. The parameter set depends on a hearing loss of the wearer of hearing device 2 and was set by an audiologist or by means of another method.

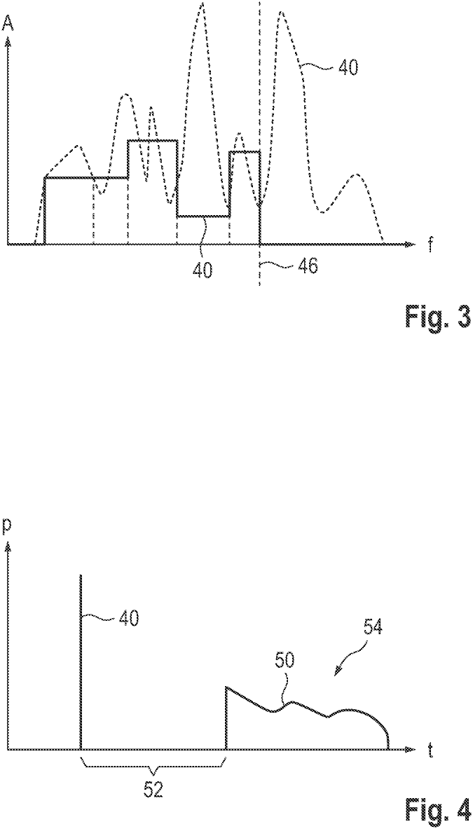

In a fourth work step 44, performed substantially concurrently with the third work step 42, a speech intelligibility of second audio signal 40 is reduced. For this purpose, second audio signal 40 is filtered by means of a low-pass filter which is a component of signal processing unit 10, so that subsequently the frequency spectrum of second audio signal 40 shown in FIG. 3 has only frequencies which are below a cutoff frequency 46 which is operated at 100 Hz. The original second audio signal 40 is shown as a dotted line in FIG. 3. In addition, a spectral resolution of the remaining portion of second audio signal 40 is reduced, so that it has only five different frequencies/frequency bands in the example shown. In addition, a dynamic range of second audio signal 40 is reduced so that a distance between the minima and maxima of the amplitudes of the different frequency bands is limited. Furthermore, individual frequencies/frequency bands, in the example shown the second highest, are excessively attenuated so that a frequency selective amplification occurs. Subsequently, the frequency spectrum of second audio signal 40 has the shape shown by the solid line in FIG. 3.

A fifth work step 48 is then carried out. In this step, a reverberation 50 shown in FIG. 4 is added to the (processed) second audio signal 40. For this purpose, second audio signal 40 is again mapped onto itself after a reverberation time 52, wherein a frequency response 54 is adjusted. This is achieved by means of an appropriate convolution performed by signal processing unit 10. Here, frequency response 54 and reverberation time 52 of reverberation 50 are changed randomly. As a result of the processing in the fourth and fifth work steps 44, 48, the fragments of conversation originally contained in second sound 30 are no longer intelligible in second audio signal 40 processed in this way, but are merely present in an indistinct or washed-out form.

In a subsequent sixth work step 56, first audio signal 38 and second audio signal 40, therefore, the processed audio signals 38, 40, are combined to form an output signal 58. For this purpose, first audio signal 38, as it is present after third work step 42 is performed, is added to second audio signal 40, attenuated by half, as it is present after fifth work step 48, and this result is used as output signal 58.

In a subsequent seventh work step 60, output signal 58 is applied to output device 12 and thus output by it. As a result, output sound 14 is created and introduced into sound tube 16. Output sound 14 contains first sound 28 adapted to the hearing loss or components corresponding thereto. In addition, output sound 14 contains second sound 30, wherein, however, the speech intelligibility has been reduced. Thus, it is easier for the wearer of hearing device 2 to follow the desired conversation corresponding to first sound 28.

If a different current listening situation 34 was determined in first work step 24, the speech intelligibility of second audio signal 40 is reduced in a different manner and to a different extent in fourth work step 44 and fifth work step 48. For example, if it has been determined that the wearer is in a forest or in a quiet environment, wherein the first and second sounds 28, 30 are present, wherein no human voice is present in second sound 30, the speech intelligibility of second audio signal 40 is not reduced or is reduced only relatively slightly. Thus, for example, reverberation 50 is not added, and the spectral resolution is also not reduced. Thus, a loss of information for the wearer of hearing device 2 is reduced.

The invention is not limited to the exemplary embodiment described above. Rather, other variants of the invention can also be derived herefrom by the skilled artisan, without going beyond the subject matter of the invention. Particularly, further all individual features described in relation to the exemplary embodiment can also be combined with one another in a different manner, without going beyond the subject matter of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a hearing device, the method comprising:
detecting an entire audio signal via a microphone;
dividing the entire audio signal into a first audio signal and a second audio signal;
reducing a speech intelligibility of the second audio signal;
combining the first audio signal and the second audio signal to form an output signal; and
outputting the output signal via an output device.

2. The method according to claim 1, wherein the entire audio signal is divided into the first and second audio signals by a directional microphone.

3. The method according to claim 1, wherein, to reduce speech intelligibility, the second audio signal is filtered using a low-pass filter.

4. The method according to claim 1, wherein a spectral resolution and/or dynamic range of the second audio signal are reduced in order to reduce speech intelligibility.

5. The method according to claim 1, wherein a reverberation is added to reduce speech intelligibility.

6. The method according to claim 5, wherein a frequency response and/or a reverberation time of the reverberation are changed.

7. The method according to claim 1, wherein the manner and/or extent of the speech intelligibility reduction are performed depending on a current listening situation.

8. The method according to claim 1, wherein a speech intelligibility of the first audio signal is increased.

9. A hearing device comprising:
a microphone;
an output device; and
a signal processing unit,;
wherein the hearing device is operated according to the method according to claim 1.
